(19) United States
(12) Patent Application Publication
(10) Pub. No.: US 2010/0088390 A1
(43) Pub. Date: Apr. 8, 2010

(54) DATA SHARING PROXY FOR MOBILE DEVICES

(75) Inventors: Tian Bai, Beijing (CN); Eric I-Chao Chang, Beijing (CN); Raman Chandrasekar, Seattle, WA (US); Michael Ying-Kee Tsang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,512

(22) Filed: Oct. 3, 2008

(51) Int. Cl. G06F 15/16

(52) U.S. Cl. 709/217; 709/228

(57) ABSTRACT

Described is a technology that uses a web service as a proxy for transferring data between mobile communications devices. A short range communication link is established between a source device and a destination device. The source device sends a content identifier over the short range communication link to the destination device, that the destination devices uses to access the content, including when the short range communication link no longer exists. Also described is security for the content via authentication data (e.g., credentials) and policy associated with the content to control its access. The source device may select the destination device or may broadcast the content identifier to any number of destination devices within range.

### BACKGROUND

Mobile devices users frequently transfer data to one another. Often users do this via short range transmissions, e.g., via Bluetooth®, wireless LAN, infrared, and so forth.

However, this limits the mobility of the devices, as the devices have to stay in one area during the transmission; (with infrared, not only is relatively near proximity required, but line of sight is also required). As transferred data is often relatively large, e.g., comprising pictures, audio, and/or video, this is inconvenient. At the same time, users do not want everyone to have access to their data, only a selected recipient or group of recipients.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a web service is used as a proxy to transfer data from a source device to a destination device, such as when a short range communication link no longer exists between the devices. In one aspect, a short range communication link is established between a source device and a destination device. The source device sends a content identifier over the short range communication link to the destination device, in which the content identifier is associated with content that is (or will be) accessible via the web service, including when the short range communication link no longer exists. The destination device may use the content identifier (which may be a URL or part of a URL) to download the content from the web service when desired.

In one aspect, the content may have associated policy. The policy may restrict access, may restrict redistribution, and so forth.

In one aspect, the content may have associated authentication data. If so, the source device provides the authentication data to the destination device via the short range communications link so that the destination device may access the content.

In one aspect, the source device may select the destination device to control receipt of the content identifier (and any authentication data). In an alternative, the source device may broadcast the content identifier to any number of destination devices within range.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIGS. 1 and 2 are block diagrams representing example components in a mobile communications environment, including for communication via a short range communication link, and to a web service over a web communications link.

FIG. 3 is a flow diagram representing example steps that may be taken to share data between mobile devices by using a web service as a proxy.

FIG. 4 shows an illustrative example of a mobile communications device into which various aspects of the present invention may be incorporated.

### DETAILED DESCRIPTION

Various aspects of the technology described herein are generally directed towards having a mobile device communicate with one more other computing devices, during which access to content becomes available to the receiving (destination) device. A source device uploads content identified via a content identifier to a remote (e.g., internet) service. The source device also communicates the content identifier to a destination device, typically at a different time. As part of the communication, authorization data (e.g., credentials) may be provided to the destination device limit access to the content to only desired recipients. The destination device may then access and download the content as desired, whereby the source device does not have to be near the destination device in order for the data to be transferred.

While the examples herein are directed towards mobile devices, particularly cellular telephone devices, it is understood that any devices that can be brought within short range communication distances may benefit from the technology described herein. For example, personal (and automobile-mounted) navigation devices that come within a close enough distance to communicate with one another (e.g., via a Bluetooth® link) may communicate to send and receive the content link and any authorization data.

As such, the present invention is not limited to any particular embodiments, aspects, concepts, protocols, formats, structures, functionalities or examples described herein. Rather, any of the embodiments, aspects, concepts, protocols, formats, structures, functionalities or examples described herein are non-limiting, and the present invention may be used various ways that provide benefits and advantages in mobile computing and communications in general.

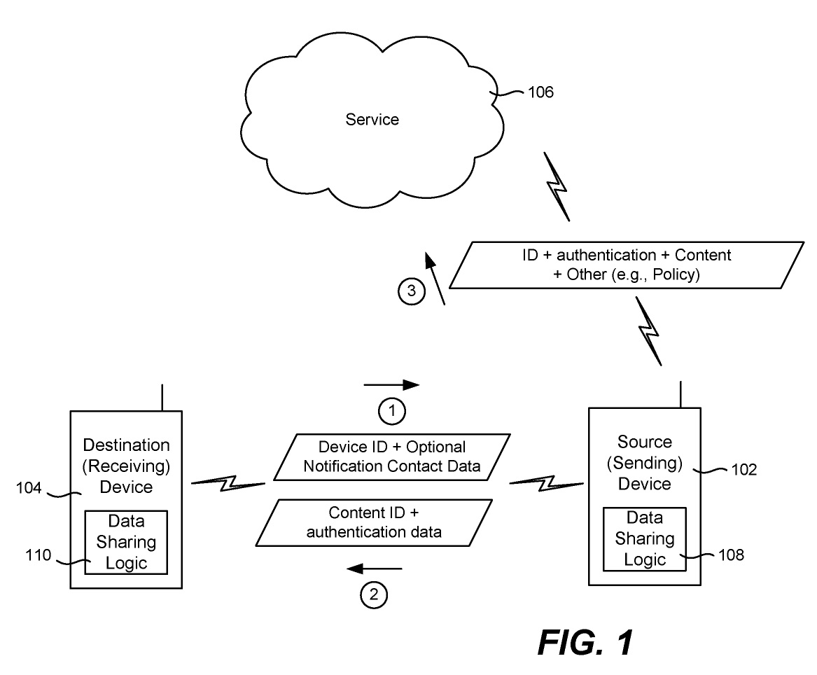

Turning to FIG. 1, there is shown a source (sending) device 102 within close proximity (e.g., capable of short-range communication) to a destination (receiving) device 104. In general, the source device 102 wants to provide the destination device 104 with access to some content.

Many such scenarios for exchanging content are possible, e.g., two people meet and one wants to provide the other with music, photographs and/or videos, a presenter at a conference wants to provide additional data to a conference attendee, and so forth. Heretofore, for short range data transmission, the content needed to be sent while the sender and recipient waited until completion, which is often inconvenient. Alternatively, a recipient needed to provide an email address (or telephone number for text messaging) to the sender, in order to later receive the content as an attachment; the sender in turn needs to reply (typically type in) the information, which is also inconvenient, and is not realistically practical in a conference-type environment where many possible recipients are interested in receiving the content.

Instead, as generally represented in FIG. 1, the destination device 104 and source device 102 automatically communicate content-related information that provides access to the content, rather than the content itself. More particularly, the source device 102 provides the destination device 104 with content identifier for the content at a web service 106, along with any authentication data that may be needed. Note that the content identifier may be a link to the content itself, or the identifier may a reference to the content accessed via the service 106; (the identifier may also include a link to the service 106 that provides the content). Data sharing logic 108, 110 (e.g., executed as part of a software program) in each device 102, 104 perform the automatic exchange.

To perform the communication, the two devices connect for communication in some way, such as is currently done for short range data exchange. Recent technology, described in U.S. patent application Ser. No. 12/131,122 (herein incorporated by reference) allows a user to gesture with one device towards another to couple with that device for communication. Note that the source device 102 may want to verify that the correct destination device 104 is coupled, so the destination device 104 may provide a device identifier, friendly name or the like to the source device 102 so that the source device 102 can verify that the destination device 104 is correct. This is represented in FIG. 1 by the arrow labeled with circled numeral one (1). Note that in one alternative, the destination device 104 may further provide contact information to the source device 102 so that the destination device 104 (or another device, such as any device by which the user receives email) can receive a notification from the service when the content is available for access. Although shown in FIG. 1 via the arrow labeled one (1), this contact information may be provided at any time during the exchange.

To start the data transfer corresponding to the content, the source device 102 shares a content identifier and optional authorization data to the destination device 104, as represented in FIG. 1 via the arrow labeled two (2). As also shown in FIG. 1 via the arrow labeled three (3), the source device 102 uploads the content to the web service, as referenced by the content identifier, along with any authorization data that the service checks before providing access to the content. In one aspect, the source device 102 also may associate policy data (e.g., restrictions, conditions and so forth) with the content, such as a content expiration time, how may downloads total are allowed, which device or devices can download (to deny access to another device even if it has the correct authentication data), whether the content can be redistributed by the recipient, and so forth.

It should be noted that the upload make occur at any time, whether before during or after any inter-device communications (e.g., arrows one (1) and/or two (2)). For example, a user may place content on the service, and later go around giving access to the content to various destination devices 104. Alternatively, a user may give out access, and then later upload the content, such as when the user gets home. Moreover, although FIG. 1 shows the source device 102 uploading the content, a different device such as a home personal computer can upload the content, with the source device 102 only used for communicating the content identifier and/or authentication information to destination device 104 or devices.

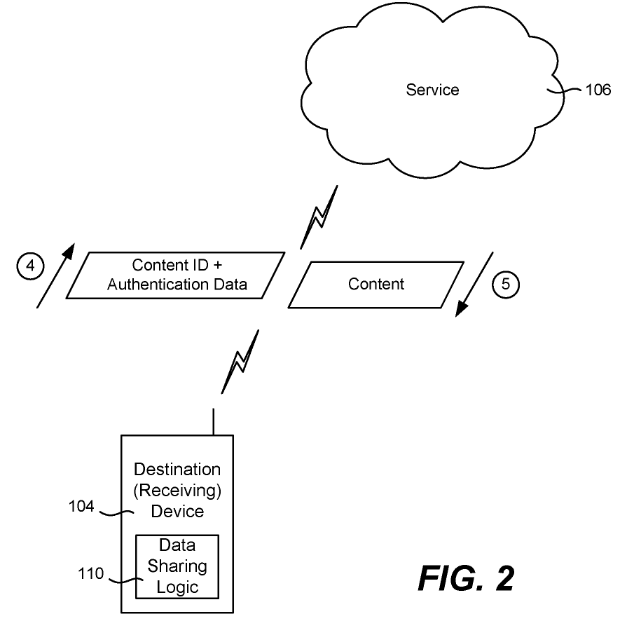

To obtain the content via the web service, at some later time as generally represented in FIG. 2, the receiving device sends the content identifier and the authorization data (the arrow labeled four (4)) to the web service 106. Note that this can be as soon as the content is available, which may be right away if previously uploaded, although the destination device 104's user may choose to wait, e.g., for Wi-Fi connectivity, if operating on a low battery, and so forth. To download, after passing an authentication process (if appropriate), the desired content is then delivered (downloaded) from the web service to the receiving device (the arrow labeled five (5)). As can be appreciated, this allows users to share information without the need to stay in one area during the transmission. As with the upload, the download may be to a different device, e.g., the destination device 104 may be used for receiving the content identifier and/or authentication information from the source device 102.

Note that in one alternative, while still within range as in FIG. 1, the source device 102 may also begin sending at least some of the content directly to the destination device 104, such as after providing the content identifier and authorization data. However, in this alternative, because the destination possesses the content identifier and authorization data, the destination can later get the content even if the communication terminates before the content is fully sent over the close-range connection. Note that a set of content may be sent in sub-parts; for example, a group of content identifiers may be provided to the destination device 104, (or one main content identifier with sub-identifiers), whereby smaller pieces of content may be separately received. The destination's data sharing logic 110 can track which content parts are received and which are needed.

In one aspect, a source device 102 may make its content available at the same time to numerous destination devices 104 in a broadcast mode. As one example, consider a presenter at a conference who wants to provide content to any interested attendee. Such a controlled target audience provides numerous direct marketing opportunities. Via a broadcast mode, the presenter can announce to interested recipients to run their data sharing logic 108, 110 (assuming they are properly equipped) to receive the content identifier/authorization data, and then send the information to all interested recipients at the same time.

As can be readily appreciated, access may be provided to any type of content, and indeed the content may be tracked, e.g., via tracking information associated with (e.g., incorporated into, accompanying, appended to, encoded into or the like) the content identifier. For example, a business may provide coupons to a set of recipients, which in turn may be redistributed; when one of those coupons gets used, the initial recipient of that coupon may be tracked, and for example be credited for successfully distributing the coupon. As another example, a sales person may give different types of sales presentations to potential customers, and provide access to some content that results in sales; by tracking the date (e.g., as part of the content identifier), the presentation that resulted in the greatest hit rate may be used to determine which type of presentation is the most successful. A business that wants some content viewed may reward the presenter at a conference who has the highest hit rate with respect to getting attendees to view the content.

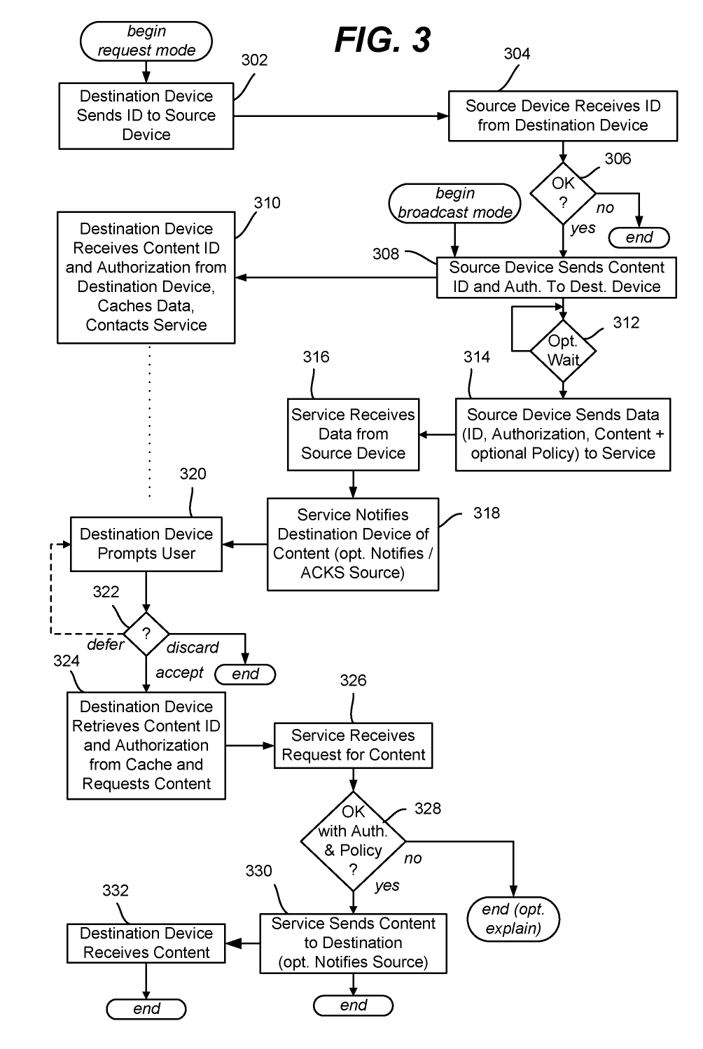

Turning to an example implementation, FIG. 3 shows some example steps that may be used (e.g., by the logic 108, 110). In FIG. 3, the steps of the destination device 104 (the device that may want to receive content) are shown on the left, the web service's steps are shown in the center, and the steps of the source device 102 (the device that is making content accessible) are shown on the right. Each device and the web service include the logic 108, 110 needed to perform such steps.

As represented by steps 302 and 304, during communication, the destination device 104 may send an identifier to the source device 102 by which the source device 102 may identify the requesting destination device 104. For example, multiple users may be present within a room, but the owner of the source device 102 may want to ensure that only the desired destination device 104 will be given access to the content. Note that some back and forth communication may occur, e.g., the source device 102 may send a message back to the destination device 104 that causes it to flash and/or beep so that the source device 102 owner can physically see that the correct destination device 104 is identified. Via step 306 the user of the source device may decide to continue to step 308, or end the session and possibly attempt a (private) re-connection to the correct device.

Note that as described above, a broadcast mode may be used, in which the owner may choose to send out the content access data to multiple recipients. If so, the owner may not be interested in verifying the recipients' identities, and may skip the ID check at step 306.

If broadcasting, or if at step 306 the source user determines that the destination identifier is OK, e.g., the owner verifies that it is the correct device, then the process continues. Once verified, at step 308 the source device 102 sends a link, along with any desired authentication information (e.g., a key) to the destination device 104.

At step 310, the destination device 104 receives the content identifier and the authorization data, which it caches for later use in accessing the content. At this time or some later time, the destination device 104 may provide the source with a way it can be notified, or contact the service directly with such information, so as to be able to receive a notification when the content is available for download. Note that a model without any notification, e.g., in which the destination attempts to access the content via occasional polling, is one alternative.

As generally represented by step 314, the source device 102 uploads data to the service, including the content, authorization and/or any policy data. Some or all of this data may have been uploaded in advance, e.g., the content may be available, with different authorization data and policy needed for each new user; alternatively the content, key and policy may be the same for all users, whereby the various data may have been uploaded at any time, awaiting any user that has the authorization data. Further, some or all of the upload may be deferred (step 312), such as until the source device 102 is within range of a Wi-Fi link. In any event, at some time the service has the various data needed to serve the content to proper recipients, that is, according to the policy and authorization credentials as specified by the content owner.

When the data is available at the service, and if the service knows how to contact a possibly interested recipient, the service may notify that recipient (step 318) based upon whatever mechanism (e.g., email or text message) that the destination device 104 told the service to use for the notification. Note that a link to the actual content may be provided with the notification, that is, not the same link that the destination device 104 used to contact the service to request the notification. Further, note that the source device 102 may receive a notification (e.g., an acknowledgement) that the destination device 104 has been notified of the content's availability.

When the notification is received or polling indicates that the content is available, (or at some later time such as when the destination device 104 also has internet access), the device may prompt the user to decide whether to download the content, as generally represented by step 320. Via step 322, the user may discard the offer, e.g., if the user has changed his or her mind and does not want the content, may defer the decision, or may accept the download. Note that the download may be automatic, such as if the user configures the device to do so rather than prompt. In a model in which no notification is given, the destination device 104 can manually or otherwise poll for content availability, and then when available, prompt or automatically download depending on how configured.

In order to receive the content, as generally represented via step 324, the destination device 104 needs to identify the content and provide any authentication data (credentials) that it has cached. The destination also may need to comply with any other specified policy (e.g., a one-time download limit cannot be exceeded, the device may need to be the same one that initially received the authentication data, and so forth).

If at step 326 the service receives the proper authentication data and policy is met (step 328) for that content identifier, the service sends the corresponding content, which is received by the destination device 104 at step 332. Note that if not sent, an explanation may be sent in its place, e.g., the owner removed the content, the content or authentication data expired, certain policy was not met, and so forth.

As can be readily appreciated, there is provided a mechanism to obtain content based upon a short range communication between a source device and a destination device, without needing to maintain the short range connection to transfer the content. Authentication data and policy data may be used to limit access to that content.

### Exemplary Operating Environment

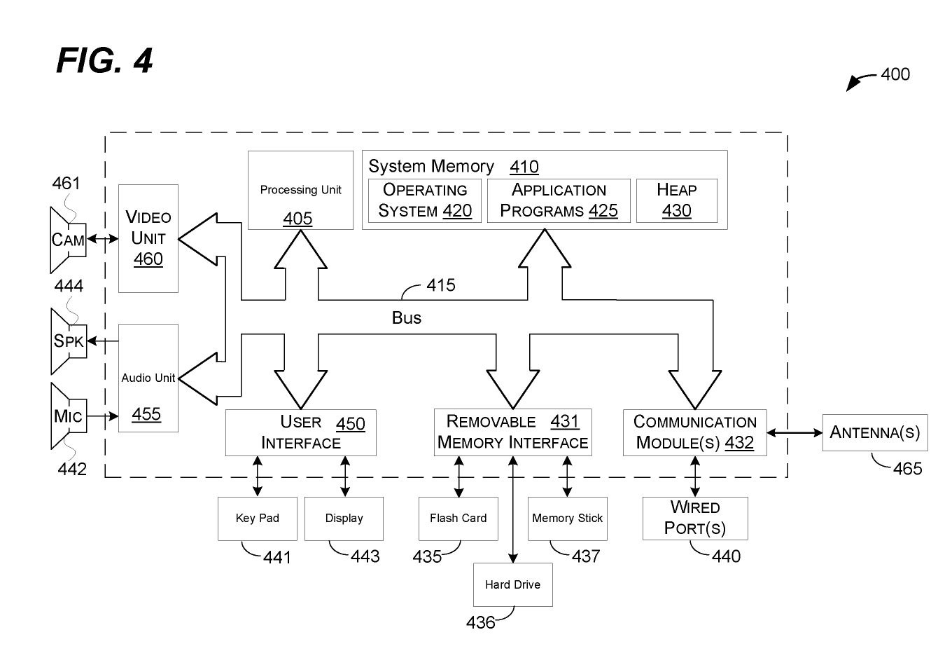

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 comprises a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, BlueTooth, Wireless USB, infrared, WiFi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-137 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a media playback device, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a source device in a mobile communications environment, a method comprising, establishing a short range communication link with a destination device, and sending a content identifier over the short range communication link to the destination device, the content identifier associated with content that is or will be accessible via a web service, including when the short range communication link no longer exists.

2. The method of claim 1 further comprising, uploading the content to the web service from the source device.

3. The method of claim 1 further comprising, associating policy with the content.

4. The method of claim 1 further comprising, associating authentication data with the content that makes the content inaccessible for download to devices without corresponding authentication data.

5. The method of claim 4 further comprising, sending corresponding authentication data over the short range communication link to the destination device.

6. The method of claim 1 further comprising, selecting the destination device from among a plurality of possible other devices.

7. The method of claim 3 further comprising, verifying that the destination device is correctly selected before sending the content identifier.

8. The method of claim 1 wherein the content identifier is sent to the destination device via a broadcast mode transmission that makes the content identifier available to any other device within the short range communication link that is capable of receiving the content identifier.

9. The method of claim 1 further comprising, sending part of the content while the short range communication link remains established.

10. The method of claim 1 further comprising associating tracking information with the content identifier.

11. The method of claim 1 further comprising receiving a notification from the web service indicating that the destination device has been notified of the content being available for access.

12. The method of claim 1 further comprising receiving a notification from the web service indicating that the destination device has downloaded at least part of the content.

13. The method of claim 1 wherein establishing the short range communication link with the destination device comprises gesturing to establish a connection.

14. In a communications environment, a system comprising, a web service that provides access to content corresponding to a content identifier associated with a source device, the content accessible to a requesting device over a web connection, in which the content identifier is initially sent by the source device via a short range communications link with a destination device.

15. The system of claim 14 wherein the web service receives authentication data associated with the content, and wherein the web service requires corresponding authentication data to be provided by the requesting device in order to access the content.

16. The system of claim 14 wherein the web service receives policy data associated with the content, and wherein the web service enforces policy with respect to whether the content is downloadable to the requesting device.

17. In a destination device in a mobile communications environment, a method comprising, establishing a short range communication link with a source device, receiving a content identifier over the short range communication link from the source device, the content identifier associated with content that is or will be accessible via a web service, including when the short range communication link no longer exists, and accessing the content via the web service over a different communications link.

18. The method of claim 17 further comprising, receiving authentication data associated with the content identifier, and wherein accessing the content includes providing the authentication data.

19. The method of claim 17 further comprising, receiving part of the content while the short range communication link remains established.

20. The method of claim 1 further comprising, receiving a notification from the web service indicating that the content is available for access.
